(19) United States
(12) Patent Application Publication
(10) Pub. No.: US 2011/0148930 A1
(43) Pub. Date: Jun. 23, 2011

(54) AUTOMATIC ADJUSTMENT OF A DISPLAY PARAMETER BASED ON VIEWER DISTANCE

(75) Inventors: Gilbert Y. Lee, Poughkeepsie, NY (US); Hon Ting Lo, Poughkeepsie, NY (US); Thomas E. Murphy, JR., Poughkeepsie, NY (US); Rafael R. Polanco, Poughkeepsie, NY (US); Daniel H. Joo, Syosset, NY (US)

(73) Assignee: INTERNATIONAL BUSINESS MACHINES CORPORATION, Armonk, NY (US)

(21) Appl. No.: 12/641,563

(22) Filed: Dec. 18, 2009

(51) Int. Cl. G09G 5/00; G09G 5/02

(52) U.S. Cl. 345/660; 345/699

(57) ABSTRACT

A display system includes a display having at least one display parameter, a controller operatively coupled to the display, and a sensor operatively coupled to the controller. The sensor is configured and disposed to detect a distance between the display and a person viewing the display. The controller is configured and disposed to automatically reconfigure the at least one display parameter based on the distance between the display and the person viewing the display detected by the sensor.

### BACKGROUND

The present invention relates to display systems and, more particularly, to a system for automatically adjusting a display parameter based on viewer distance from the display.

Conventional displays include various parameters such as resolution, contrast, color quality and the like. Typically, the display parameters are manually set when first setting up a display system and remain unchanged. While the settings remain unchanged, often times the viewer themselves will change, or be in an environment that is different than when the display was first setup. For example, when working at a computer, a user may change a seating position and, as a result, alter a distance between the screen and his/her eyes. This change in distance may make reading information on the display difficult. One solution, to at least the distance problem is to employ an active emitter on the user and a sensor on the display. The sensor is configured to detect active emissions from the emitter. The active emissions such as ultrasound waves, RFID signals and the like are utilized to determine a distance between the user and the screen. Based on this distance, the resolution of the display may be changed. Active emitters are generally costly devices that must be borne by the user for the system to function. Moreover, the system must include a receiver that itself is costly and not conducive to implementation on existing systems.

### SUMMARY

According to one exemplary embodiment a display system includes a display having at least one display parameter, a controller operatively coupled to the display, and a sensor operatively coupled to the controller. The sensor is configured and disposed to detect a distance between the display and a person viewing the display. The controller is configured and disposed to automatically reconfigure the at least one display parameter based on the distance between the display and the person viewing the display detected by the sensor.

According to another exemplary embodiment, a method of adjusting a display parameter of a display includes detecting a person viewing the display, determining a distance between the display and the person viewing the display, and automatically adjusting the display parameter based upon the distance between the display and the person viewing the display.

A system for automatically adjusting a display parameter of a display is also described and claimed herein.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a perspective view of a person viewing a display constructed in accordance with an exemplary embodiment;

FIG. 2 is a flow chart illustrating a method of adjusting a display parameter of the display of FIG. 1 based on a distance between the display and the person viewing the display;

FIG. 3 is a flow chart illustrating a method of establishing a user profile, including establishing a distance reference, for the person viewing the display;

FIG. 4 is a flow chart illustrating a method of monitoring the distance between the display and the person viewing the display; and

FIG. 5 is a block diagram of a general-purpose computer configured and disposed to adjust a display parameter based on a distance between a display and a person viewing in accordance with an exemplary embodiment.

### DETAILED DESCRIPTION

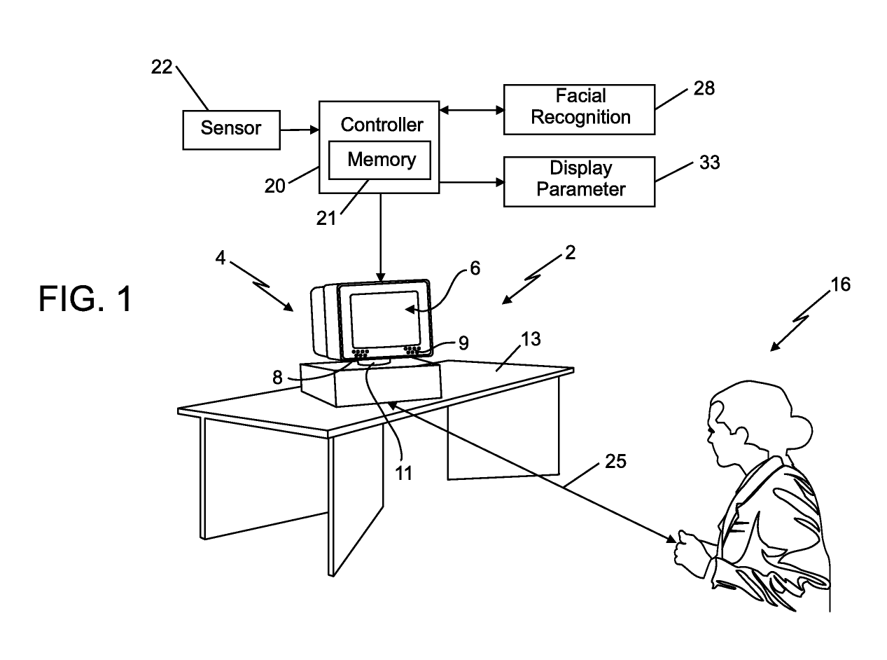

With reference now to FIG. 1, a display system constructed in accordance with an exemplary embodiment is indicated generally at 2. Display system 2 includes a display 4 having a display screen 6 as well as a pair of speakers 8 and 9. A base 11 supports display 4 upon a desktop 13 in front of a person or viewer 16 viewing display 4. Although shown supported upon a desktop, it should be understood that display system 2 could also be wall mounted or formed as part of another structure or appliance.

In further accordance with an exemplary embodiment, display system 2 includes a controller 20 having a memory 21. Controller 20 is operatively coupled to a sensor 22 which, as will be detailed more fully below, cooperates with controller 20 to determine a distance 25 between viewer 16 and display 4. In accordance with one exemplary embodiment, controller 20 employs a facial recognition system 28 to determine distance 25. Based upon the determined distance, controller 20 automatically adjusts a display parameter(s) 33 of display 4 according to previously defined display settings. Display parameter 33 includes, for example, previously defined combinations of screen resolution settings (as defined in pixels) along with associated color quality selections typically defined as 16 or 32 bits. Such display property changes effect the proportional overall rendering density of all images, graphics and text at display 4. In addition, distance recognition may include an associated setting to adjust audio output level/volume from speakers 8 and 9. In further accordance with the exemplary embodiment, sensor 22 captures an image viewer 16. The image is passed to controller 20 for analysis. Controller 20 then analyzes the ratio of a facial pixel compared to overall pixel usage in the image to determine distance 25. The analysis compares facial pixels, e.g., the number of pixels that define a facial image, with the number of pixels in the entire view captured by the camera. Hence a larger ratio of facial pixels implies a closer positioning and as someone moves away from the camera the ratio of facial pixels (or dots) decreases implying a positioning further from the camera. At this point, it should be understood, that while sensor 22 is described as a camera, other forms of distance measuring devices such as video cameras, infrared devices, lasers, and the like can also be employed.

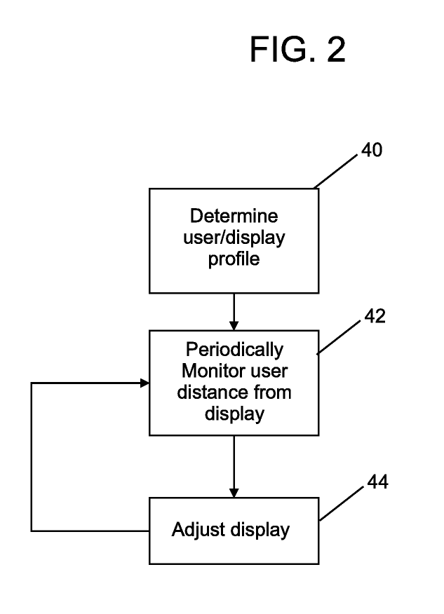

Reference will now be made to FIG. 2 in describing a method of adjusting a display parameter 33. As shown, controller 20 initially determines or establishes a user/display profile that includes a distance reference, as indicated in block 40 in a manner that will be described more fully below. After establishing the user/display profile, the distance between viewer 16 and display 4 is periodically monitored as indicated in block 42 in a manner that will also be described more fully below. Based on the monitored distance between viewer 16 and display 4, controller 20 adjusts the display parameter(s) of display 4 in order to enhance the viewing experience of the viewer. As an alternative to the automatic operation describe above, viewer 16 can manually signal a change in the display via a keystroke sequence or the like, or the change can be triggered by a change in network or through a voice command (semi-automatic operation). In addition, the change can be selected to occur after a period of time allowing the viewer to select a desired display parameter 33 and return to a desired distance from display 4.

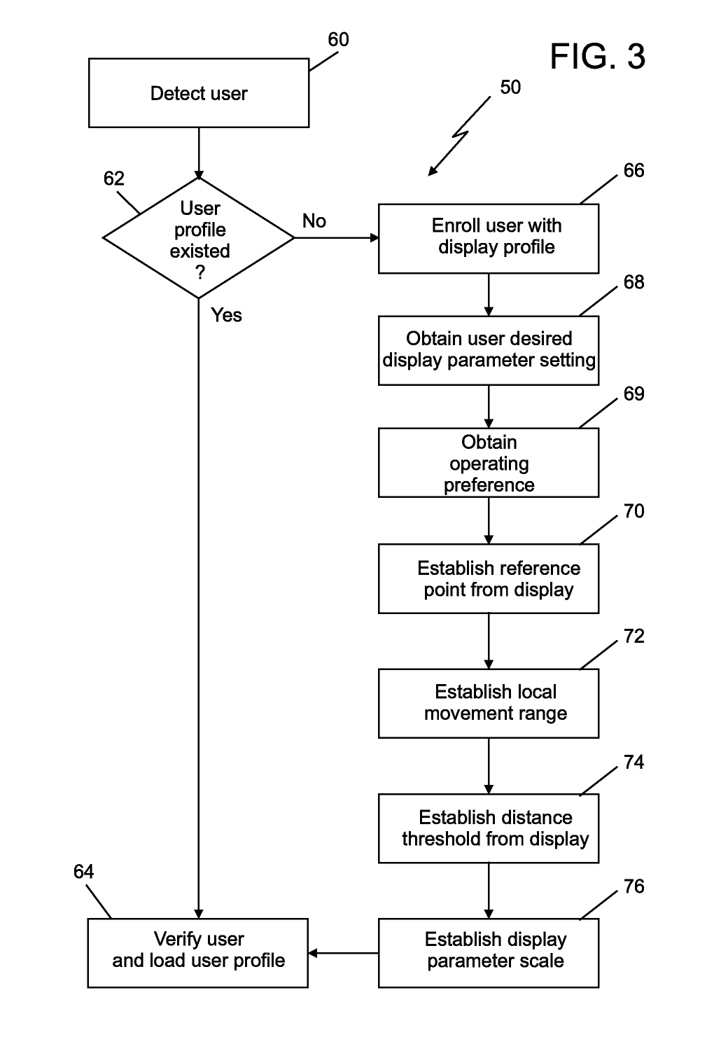

Reference will now be made to FIG. 3 in describing a method 50 of establishing a display profile for a viewer of display 4. Initially, controller 20 detects the presence of a viewer in front of display 4 as indicated in block 60. Controller 20 detects the presence of the viewer via, for example, sensing an image within sensor 22, or using infrared techniques, laser techniques or the like. Alternatively, controller 20 can determine the presence of a viewer using login information or the like. If a user profile exists for the viewer, the viewer is verified and the profile is loaded into memory 21 as indicated in block 64. If the viewer does not have a user profile, a profile is established as indicated in block 66. The viewer is prompted to enter desired display parameter settings or setting combinations, such as colors, pixels, zoom level, and font size as indicated in block 68. After entering desired display parameter settings or combinations of settings, the viewer selects an operating preference as indicated in block 69. Operating preference allows the viewer a choice between automatic operation, manual operation or semi automatic operation. Controller 20 also establishes a reference point or a distance between the viewer and display 4 as indicated in block 70. Controller 20 then establishes a local movement range, that is the upper limit or furthest distance the viewer will be from display 4 and a lower limit or nearest distance the viewer will be from display 4 by monitoring the person as indicated in block 72. After establishing the local movement range, a distance threshold from the display is established in block 74. The distance threshold is defined as the maximum and minimum distance viewer 16 can be situated relative to display 4. After determining the distance threshold, controller 20 establishes a display parameter scale in block 76. The display parameter scale, which is stored in memory 22, establishes desired display parameters for each portion of the local movement range as well as for movement outside of the local movement range.

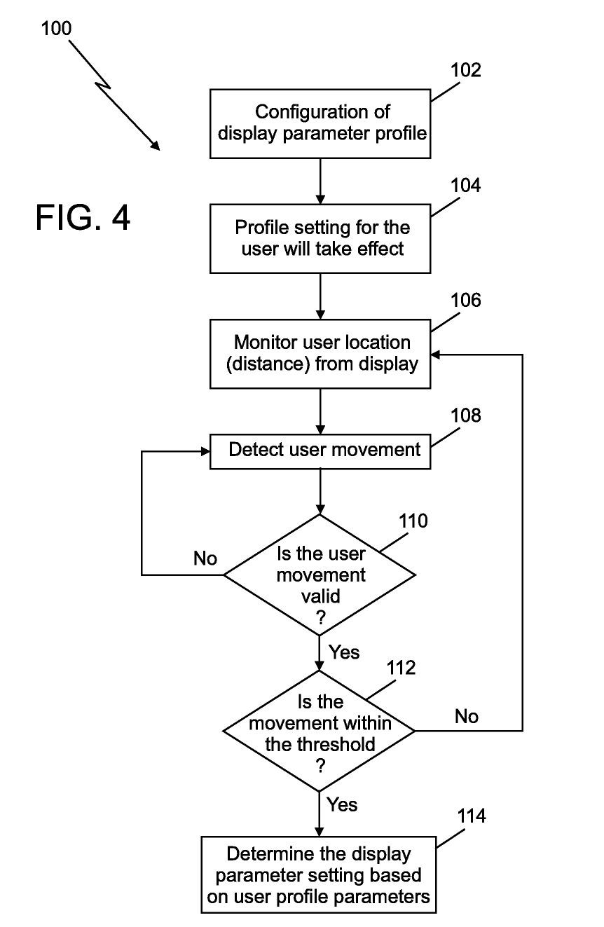

Reference will now be made to FIG. 4 in describing a method 100 of monitoring viewer distance from display 4. Initially, a display parameter profile is configured in block 102. That is, after establishing the display parameter scale in block 76, the viewer is presented with the option of making additional enhancement to the display parameter profile based on the viewer's particular preferences. After configuring the display parameter profile in block 102, a viewer profile setting is established in block 104. At this point, controller 20 continues to monitor viewer location or distance from display 4 in block 106. If controller 20 detects viewer movement in block 108, a determination is made if the viewer movement is valid in block 110. That is, controller 20 determines whether the movement represents a change in distance 25 between the viewer and display 4. If the viewer movement is not valid, i.e., the viewer has not moved from the defined local range, controller 20 continues to monitor for viewer movement in block 108. If, on the other hand, the viewer movement is valid, a determination is made whether the viewer movement is within the viewer distance threshold established in block 74 as indicated in block 112. If the viewer movement is not within the distance threshold, viewer distance is again determined, the local movement range is revised, a new parameter scale is established and the display parameter(s) is/are adjusted. If the movement remains within the threshold, the display parameter setting is adjusted based on the display parameter profile and parameter scale.

At this point, it should be understood that the present invention provides a system and method for ensuring or enhancing a viewer's experience viewing a display. By adjusting display parameters based on distance, the user's viewing experience is enhanced. That is, the user will no longer be required to manually change display parameters when moving closer to or sitting further away from display.

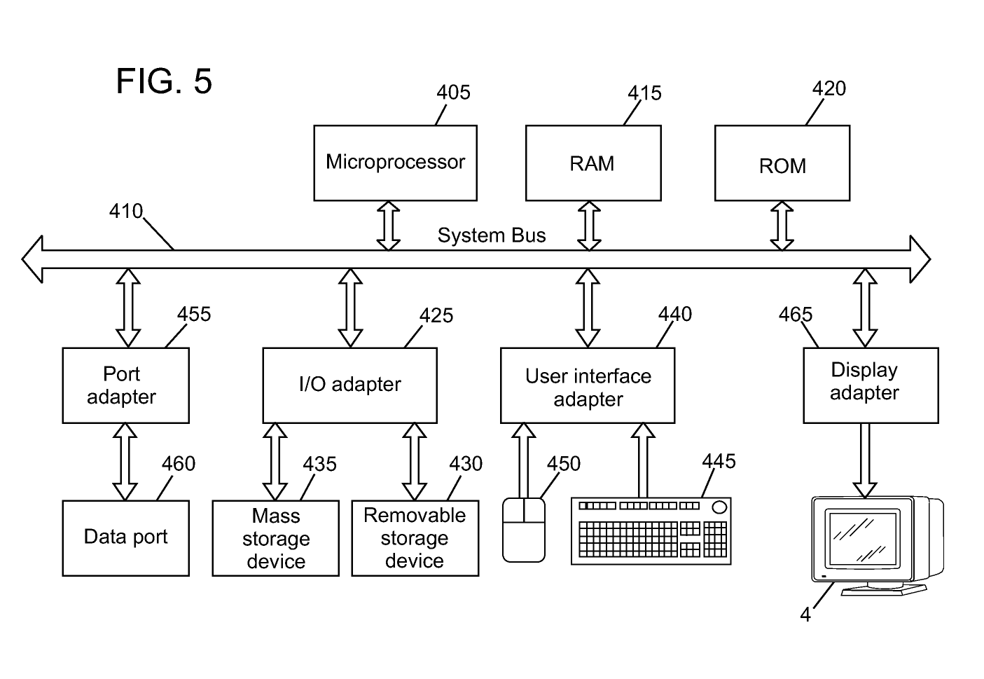

The method of adjusting a display parameter of a display described herein can also be practiced with a general-purpose computer such as illustrated at 400 in FIG. 5 and the method may be coded as a set of instructions on removable or hard media for use by the general-purpose computer 400. In FIG. 5, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for connecting a removable data and/or program storage device 430, a mass data and/or program storage device 435, a user interface adapter 440 for connecting a keyboard 445 and a mouse 450, a port adapter 455 for connecting a data port 460, a display adapter 465 for connecting display 4.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

What is claimed is:

1. A display system comprising:
a display including at least one display parameter;
a controller operatively coupled to the display; and
a sensor operatively coupled to the controller, the sensor being configured and disposed to detect a distance between the display and a person viewing the display, wherein the controller is configured and disposed to automatically reconfigure the at least one display parameter based on the distance between the display and the person viewing the display detected by the sensor.

2. The display system according to claim 1, wherein the sensor is a camera configured and disposed to capture an image of the person viewing the display.

3. The display system according to claim 2, wherein the controller includes a facial recognition algorithm, the controller determining the distance between the display and the person viewing the display based upon a facial image.

4. The display system according to claim 3, wherein the controller determines a size of the facial image of the person viewing the display to determine the distance.

5. The display system according to claim 1, wherein the sensor is an infrared sensor configured and disposed to determine a distance between the display and the person viewing the display.

6. The display system according to claim 1, wherein the sensor includes a laser configured and disposed to determine a distance between the display and the person viewing the display.

7. The display system according to claim 1, wherein the at least one display parameter is screen resolution, the controller being configured and disposed to adjust display properties based on the distance between the display and the person viewing the display.

8. The display system according to claim 1, wherein in the at least one display parameter is a zoom level, the controller being configured and disposed to adjust the zoom level based on the distance between the display and the person viewing the display.

9. The display system according to claim 1, wherein in the at least one display parameter is sound, the controller being configured and disposed to adjust sound volume based on the distance between the display and the person viewing the display.

10. A method of adjusting a display parameter of a display, the method comprising:
detecting a person viewing the display;
determining a distance between the display and the person viewing the display; and
adjusting the display parameter based upon the display and the person viewing the display.

11. The method of claim 10, further comprising: establishing a user profile for the person viewing the display, the user profile including display parameter preferences based on the distance between the display and the person viewing the display.

12. The method of claim 11, further comprising:
establishing a distance threshold from the display; and
creating a display parameter scale based on the distance threshold.

13. The method of claim 10, further comprising: capturing an image of a person adjacent the display.

14. The method of claim 13, wherein determining a distance between the display and a person adjacent the display includes a size of a facial image from the image of the person adjacent the display.

15. The method of claim 10, wherein adjusting the display parameter includes adjusting at least one of size of zoom level of the display, and audio volume from the display.

16. The method of claim 10, further comprising:
detecting a change in the distance between the display and the person viewing the display; and
re-adjusting the display parameter based on the change in distance between the display and the person viewing the display.

17. A system for automatically adjusting a display parameter of a display, the system comprising:
a central processing unit (CPU), said CPU being interconnected functionally via a system bus to:
a sensor;
an input/output (I/O) adapter connecting to at least one of a removable data storage device, a program storage device, and a mass data storage device;
a display adapter connecting to a display device; and
at least one memory device thereupon stored a set of instructions which, when executed by said CPU, causes said system to:
receive a signal representing a distance between the display and a person viewing the display; and
automatically adjust the display parameter based upon the distance between the display and a person viewing the display.

18. The system of claim 17, further comprising:
capturing an image of a person viewing the display;
isolating a portion of the image of the person viewing the display; and
analyzing a size of a facial image from the portion of the image of the person viewing the display, wherein the distance between the display and the person viewing the display is determined based on the size of the facial image.
